(19) United States
(12) Patent Application Publication
(10) Pub. No.: US 2007/0011482 A1
(43) Pub. Date: Jan. 11, 2007

(54) Clock generator, radio receiver using the same, function system, and sensing system

(75) Inventors: Akihide Sai, Kawasaki (JP); Takeshi Ueno, Kawasaki-shi (JP); Takafumi Yamaji, Yokohama-shi (JP); Tetsuro Itakura, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/438,589

(22) Filed: May 22, 2006

(30) Foreign Application Priority Data
Jul. 11, 2005 (JP) 2005-201979

(51) Int. Cl. G06F 1/00

(52) U.S. Cl. 713/500

(57) ABSTRACT

A clock generator having phase locked loops to receive reference signals from a shared reference signal source and generate clock signals differing in frequency, respectively, includes a phase comparator which generates a voltage signal in response to a phase difference between a phase of the reference signal and a phase of a feedback signal, a VCO controlled by a voltage signal from the phase comparator, and a frequency divider group connected in cascade in a feedback loop between an output of the VCO and an input of a feedback signal, and takes out a clock signals from each output of the frequency divider group.

### CROSS-REFERENCE TO RELATED APPLICATIONS

This application is based upon and claims the benefit of priority from prior Japanese Patent Application No. 2005-201979, filed Jul. 11, 2005, the entire contents of which are incorporated herein by reference.

### BACKGROUND OF THE INVENTION

1. Field of the Invention

The present invention relates to a clock generator, a radio receiver using the same, a function system and a sensing system.

2. Description of the Related Art

A clock signal necessary for a function unit including a digital electronic circuit is generated by generally using a phase-locked loop (PLL). The PLL, as is known well, includes a phase comparator, a voltage controlled oscillator (VCO) and a low-pass filter as principal components. The phase comparator compares a phase of a reference signal with a phase of a feedback signal to generate a voltage signal corresponding to a phase difference between both signals. The VCO outputs a signal with a frequency controlled by the voltage signal supplied from the phase comparator via the low-pass filter. The output signal from the VCO is supplied to a feedback signal input of the phase comparator.

A clock generator generating a plurality of clock signals with different frequencies to be supplied to one function unit is disclosed on the fourth page and in figure 1 of Jpn. Pat. Appln. KOKAI Publication No. 2004-356801 (hereinafter, referred to as patent document 1). The clock generator is realized by a PLL and a frequency divider group connected in cascade to an output of the VCO out of a feedback loop of the PLL and outputs clock signals differing in frequency from each frequency divider of the frequency divider group.

On the other hand, in a system including a plurality of function units, a shared clock generator generally distributes a plurality of clock signals with different frequencies to each function unit, respectively.

However, when the shared clock generator distributes the clock signals to a plurality of function units mounted on different integrated circuit (IC) chips, it is needed to route for wires out of the chips for distributing high-frequency clock signals to each function unit to be routed up to each of the function units. As a result, since long wires out of the chips have to be driven at high-speed, an increase in power consumption and an occurrence of electromagnetic interference (EMI) noise become problems.

The problems are solved by disposing each clock generator on the IC chips with each function unit mounted thereon and by routing wires to each for supplying low-frequency reference signals to PLLs up to the PLLs on a substrate. However, the arrangement of such clock generators described in the patent document 1 onto the chips with each function unit mounted thereon possibly inverts the phases of the clock signals generated by each clock generator against one another depending on initial states of the group of the frequency dividers. Such phase inversion phenomena of the clock signals are undesirable in a system, for example, achieving a specific function in cooperation with a plurality of function units.

### BRIEF SUMMARY OF THE INVENTION

An object of the present invention is to provide a clock generator which does not need to route a long wire for distributing clock signals and also can put clock signals with the same frequency in phase with one another, a radio receiver using the same, a function system and a sensing system.

As an aspect of the present invention, a clock generator having a plurality of PLLs to generate a plurality of clock signals different in frequency by receiving reference signals from a shared reference signal source, respectively, is provided. And each of the PLLs includes a phase comparator which compares a phase of a reference signal with a phase of a feedback signal to generate a voltage signal in response to a phase difference between the reference signal and the feedback signal, a voltage controlled oscillator of which the output signal is controlled in frequency by a voltage signal, a feedback loop disposed between an output of the voltage controlled oscillator and an input of the feedback signal of the phase comparator, a first frequency divider which is connected to the voltage controlled oscillator in the feedback loop to output a first clock signal, a second frequency divider which is connected to the first frequency divider to output a second clock signal, a first output terminal which takes out the first clock signal, and a second output terminal which takes out the second clock signal.

### BRIEF DESCRIPTION OF THE SEVERAL VIEWS OF THE DRAWING

FIG. 1 is a block diagram of a clock generator regarding a first embodiment of the present invention;

FIG. 2A to 2D are timing charts showing operations of the clock generator in FIG. 1;

FIG. 3 is a block diagram of a clock generator regarding a second embodiment;

FIG. 4A to 4E are timing charts showing operations of the clock generator in FIG. 2;

FIG. 5 is a block diagram of a system regarding a third embodiment of the present invention;

FIG. 6 is a block diagram showing an example of a clock generation unit;

FIG. 7 is a block diagram showing an another example of the clock generation unit;

FIG. 8 is a block diagram of a sensing system regarding a fourth embodiment of the present invention; and

FIG. 9 is a block diagram of a radio receiver regarding a fifth embodiment of the present invention.

### DETAILED DESCRIPTION OF THE INVENTION

Hereinafter, embodiments of the present invention will be described by referring to the drawings.

### First Embodiment

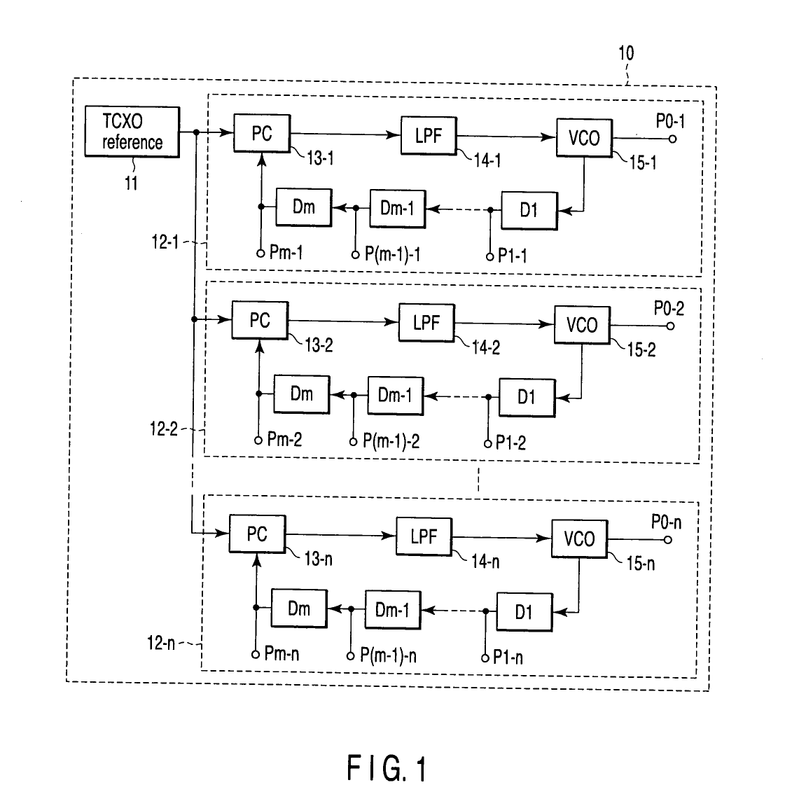

FIG. 1 shows a clock generator 10 regarding the first embodiment of the present invention. The clock generator 10 has a reference signal source 11 and a plurality (n) of phase locked loops (PLLs) 12-1 to 12-n. The reference signal source 11 generates a reference signal (hereinafter, referred to as a reference clock signal) having relatively low-frequency and high frequency accuracy which becomes a reference of a clock signal to be generated. The reference signal source 11 employs an oscillator with high accuracy, for example, a temperature compensated crystal oscillator (TCXO).

The PLLs 12-1 to 12-n each has phase comparator (PC) 13-1 to 13-n, low-pass filters (LPFs) 14-1 to 14-n and VCOs 15-1 to 15-n. Reference clock signals from the reference signal source are input to each one input (reference signal input) of PCs 13-1 to 13-n, respectively. Feedback signals are input to each the other input (feedback signal input) of the PCs 13-1 to 13-n, respectively.

Each output of the VCOs 15-1 to 15-n get connected in cascade with each frequency divider group D1 to Dm in feedback loops up to each feedback signal input of the PCs 13-1 to 13-n, respectively. Output terminals P₀₋ᵢ (i=1 to n) are connected to each output of the VCO 15-i and output terminals P₁₋ᵢ to Pₘ₋ᵢ are connected to each output of the frequency divider groups D1 to Dm in PLLs 12-i (i=1 to n), respectively. These output terminals P₀₋ᵢ and P₁₋ᵢ to Pₘ₋ᵢ of the PLL 12-i output a plurality of clock signals differing in frequency generated from the clock generator 10.

Next, operations of the clock generator 10 will be described. The PLL 12-i operates so as to coincide phases and frequencies with each other between a reference clock signal from the signal source reference and a feedback signal output from a frequency divider Dm on the last stage. Here, it is assumed that the frequency divider groups D1 to Dm vary states in response to a rising edge of an input signal.

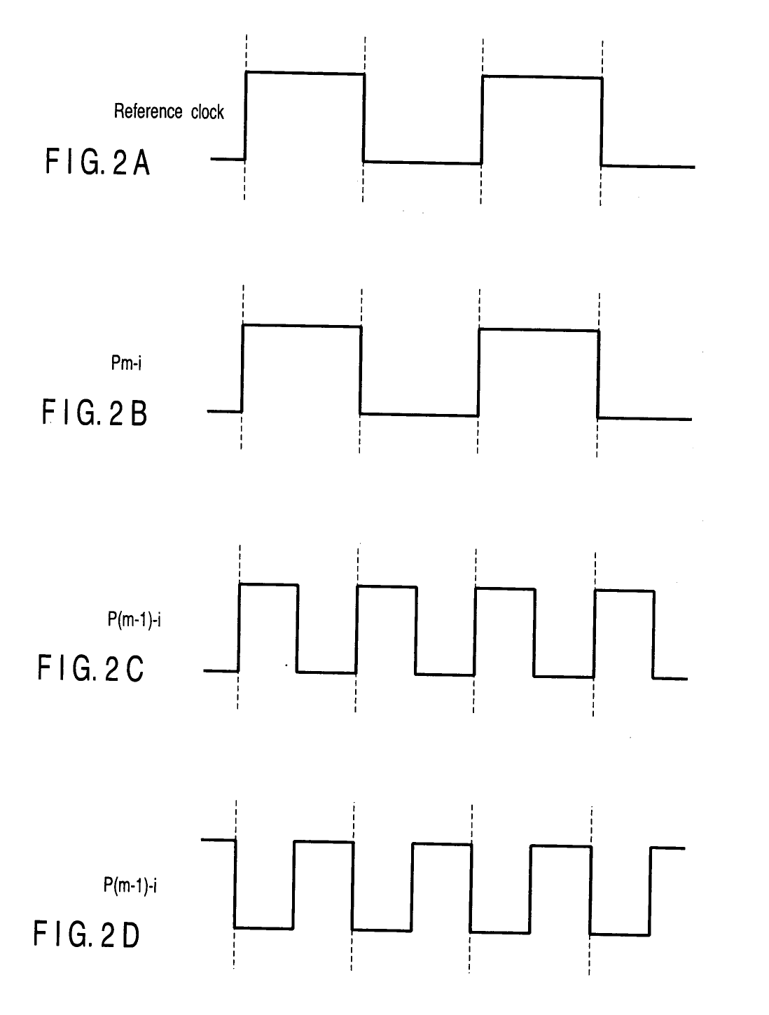

FIGS. 2A, B and C show timing charts of the reference clock signal output from the reference signal source 11 at this moment and clock signals at output terminals Pₘ₋ᵢ to P₍ₘ₋₁₎₋ᵢ. However, FIG. 2A to 2E show cases in which each of the frequency divider groups D1 to Dm divide frequencies into two, respectively.

In the case of phase synchronized states of the PLLs 12-i, namely, when the phases and frequencies of the reference clock signal and the feedback signals coincide with one another, phases and frequencies of the reference clock signal and the clock signal at the output terminals Pₘ₋ᵢ coincide with each other, as shown in FIGS. 2A and 2B. The clock signal at the output terminal Pₘ₋ᵢ vary in response to rising edges of the clock signals at the output terminal P₍ₘ₋₁₎₋ᵢ. Accordingly, it is considered that a state of the clock signal at the output terminals P₍ₘ₋₁₎₋ᵢ is only shown in FIG. 2C showing the case where the rising edges of the clock signal coincides with those of the clock signal at the output terminal Pₘ₋ᵢ shown in FIG. 2B and the state cannot become a state in FIG. 2D, which is reversed to the state in FIG. 2C.

Hereinafter, since the phases of the clock signals at output terminals P₍ₘ₋₂₎₋ᵢ, P₍ₘ₋₃₎₋ᵢ, . . . , P₀₋ᵢ are determined uniquely in a similar way, frequencies and phases at output terminals Pⱼ₋ᵢ (j=0 to m) of PLLs 12-i coincide with one another. Accordingly, a plurality of clock signals with arbitrary frequencies of which the phases are synchronized with the reference clock signal can be taken out from the output terminals Pⱼ₋ᵢ. The case in which the frequency divider groups D1 to Dm vary their states in response to falling edges of the input signals goes same.

By taking application of the clock generator 10 to a system including a plurality of function units disposed on separate IC chips into consideration, the PLLs 12-i are each disposed on the IC chips with each function unit respectively mounted thereon. The reference signal source 11 is disposed at a place different from that of on the IC chip and distributes reference clock signals to the PLLs 12-i via the wires out of the chips. Since signal passing through the wires out of the chips in such a manner are the reference clock signal with a relatively low-frequency, there is no need to drive the wires out of the chips at a high speed. Therefore, the clock generator 10 can suppress an increase in power consumption and an occurrence of EMI noise which occur in driving the wires out of the chips at the high speed.

As described above, the frequencies of the clock signals output from each output terminal Pⱼ₋ᵢ (i=1 to n, j=0 to m) of the PLLs 12-i coincide with one another and also phases of clock signals with the same frequency coincide with one another regardless of the initial states of the frequency divider groups D1 to Dm. Accordingly, the clock generator 10 can put the clock signals with the same frequency distributed to each function unit from the output terminals Pⱼ₋ᵢ of the PLLs 12-i in phase with one another. It is preferable that the phases of the clock signals with the same frequency supplied to each function unit coincide with one another as described above, for example, in a system achieving a specified function in cooperation with a plurality of function units.

### Second Embodiment

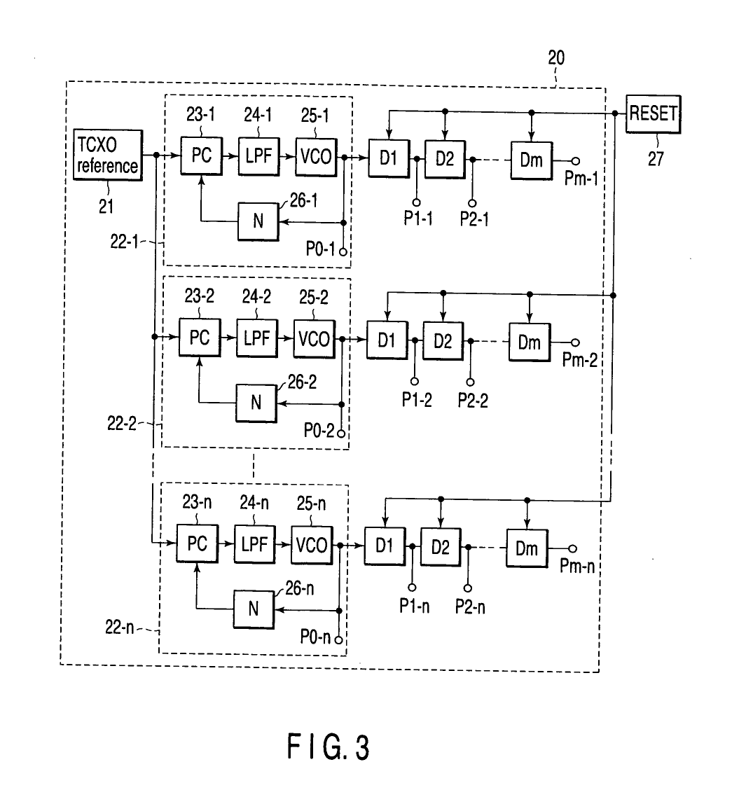

A clock generator 20 regarding a second embodiment of the present invention shown in FIG. 3 includes a reference signal source 21, PLLs 22-1 to 22-n, frequency divider groups D1 to Dm and a reset signal source 27. The PLL 22-1 has a PC 23-1, a low-pass filter 24-1, a VCO 25-1 and a frequency divider 26-1. The frequency divider groups D1 to Dm are connected in cascade to an output of the PLL 22-1 (output of VCO 25-1). PLLs 22-2 to 22-n are configured as like the PLL 22-1 and the frequency divider groups D1 to Dm are connected in cascade to outputs of the PLLs 22-2 to 22-n (VCO 25-2 to 25-n), respectively.

Reference clock signals from the reference signal source 21 are input to each one input (reference signal input) of PCs 23-1 to 23-n, respectively. Feedback signals are input to each the other input (feedback signal input) of PCs 23-1 to 23-n. An output of a VCO 25-i gets connected to an output terminal P₀₋ᵢ and outputs of the frequency divider groups D1 to Dm get connected to outputs terminals P₁₋ᵢ to Pₘ₋ᵢ, respectively. Initial states of the frequency divider groups D1 to Dm are set by a reset signal from a reset signal source 27.

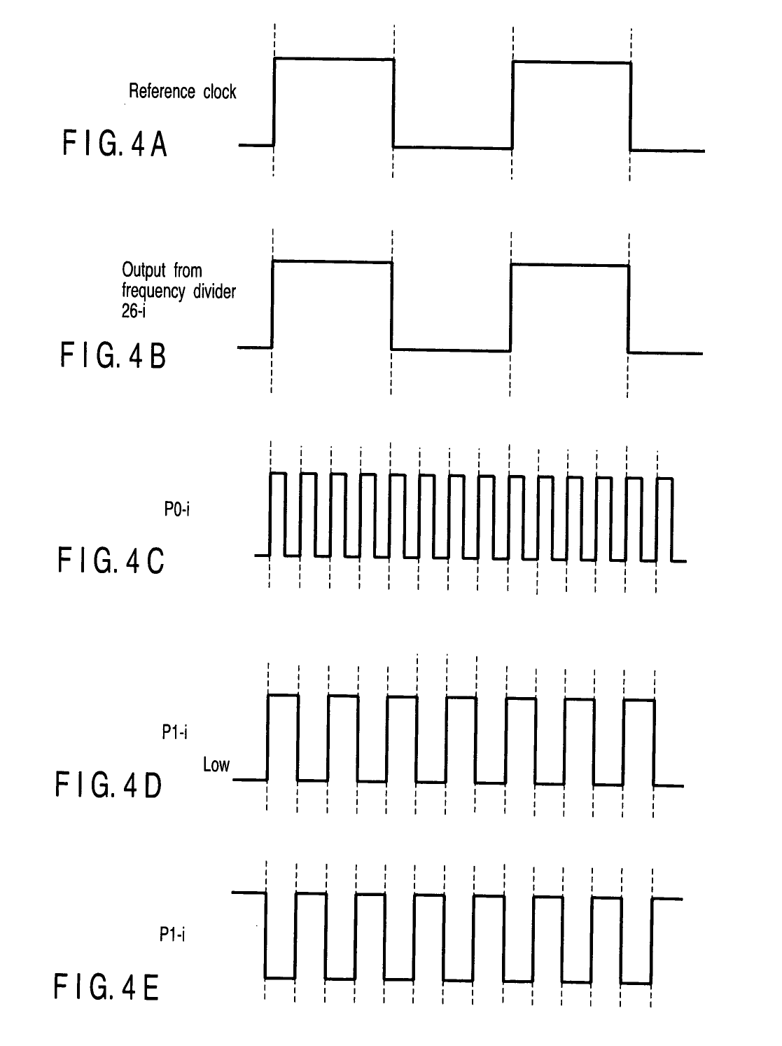

Here, it is assumed that the frequency divider groups D1 to Dm vary their states in response to a rising edge of an input signal. In such a case, FIG. 4A-4E show timing charts of the reference clock signal from the reference signal source 21, an output signal from a frequency divider 26-i in a PLL 22-i and clock signals at output terminal P₀₋ᵢ and P₁₋ᵢ. FIG. 4A-4E show as examples in the case in which a frequency dividing ratio is “4” and each frequency dividing ratio of the frequency divider groups D1 to Dm is “2”.

In the case of phase locked states of PLLs 22-i (i=1 to n), as shown in FIGS. 4A and 4B, a reference clock signal from the reference signal source 21 and a clock signal at an output of a frequency divider 26-i coincide with each other in phase and frequency. The clock signal at the output of the frequency divider 26-i varies in response to a rising edge at the output terminal P₀₋ᵢ. Accordingly, as for a state of the clock signal at the output terminal P₀₋₁, only a case of FIG. 4C, in which a rising edge coincides with the clock signal at the output of the frequency divider 26-i shown in FIG. 4B, is considered, and a state revered to FIG. 4C is impossible to be considered. Like this, the clock signals which is output from the PLLs 22-i coincide in frequency and phase regardless of the initial states of the frequency divider group D1 to Dm.

Further, by taking a state of a clock signal at the output terminal P₁₋ᵢ, two cases shown in FIGS. 4D and 4E are considered in accordance with an initial state of a frequency divider D1. However, if a level of an output from the frequency divider D1 is lowered by resetting the initial state of the frequency divider D1 through a reset signal, only a case in FIG. 4D is considered. In a similar manner, in terms of output terminals P₂₋ᵢ, P₃₋ᵢ, . . . , a state of a clock signal at an output terminal Pₘ₋ᵢ is uniquely determined by placing all initial states of the frequency divider groups D2 to Dm in the same state.

Like this manner, frequencies and phases of each clock signal at output terminals Pⱼ₋ᵢ (j=0 to m) of the PLL 22-i coincide with one another. Therefore, the clock generator 20 can takes out a plurality of clock signals with arbitrary frequencies synchronized in phase from the output terminals P₀₋ᵢ and P₁₋ᵢ. The case where the frequency divider groups D1 to Dm vary their states depending on the falling edges of the input signal goes same.

By taking an application of the clock generator 20 to a system including a plurality of function unit disposed on separate IC chips into account, the PLL 22-i and the frequency divider groups D1 to Dm connected in cascade to outputs of the PLL 22-i are arranged on the IC chips with each function unit mounted thereon, respectively. The reference signal source 21 is disposed at a position differing from a position on the IC chips with each function unit mounted thereon to distribute the reference signal to the PLL 22-i via the wire out of the chip.

As such a manner, since a signal passing through the wire out of the chip is a reference signal with relatively low-frequency, the wire is to needed to be driven at a high speed. The reset signal source 27 may also positioned at a place other than the place on the IC chips with each function unit mounted thereon. The reset signal source 27 generates reset signals to reset the initial states of the frequency divider groups D1 to Dm at any time to supplies them to the frequency divider groups D1 to Dm through the wires out of the chips. Therefore, according to the clock generator 20 in FIG. 2, the clock generator 20 can suppress the increase in the power consumption and the occurrence of the EMI noise which occur in driving the wire out of the chip at a high speed.

### Third Embodiment

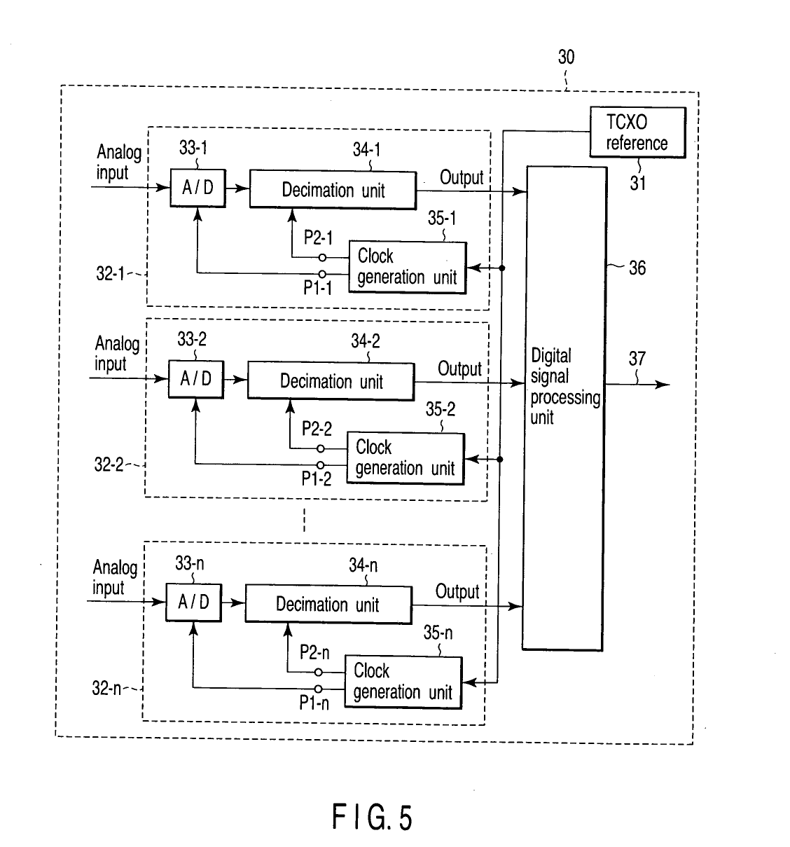

Subsequently, a third embodiment in relation to a system using a clock generator will be explained. FIG. 5 shows a function system 30 regarding the third embodiment of the present invention. The function system 30 includes a plurality of function units 32-1 to 32-n, and a shared digital signal processing unit 36 for each function unit 32-1 to 32-n. The function units 32-1 to 32-n are mounted, for example, on separate IC chips, respectively.

The function units 32-1 to 32-n have analog-to-digital (A/D) converters 33-1 to 33-n to convert input analog signals into digital signals, decimation units 34-1 to 34-n to decimate (time thinning-out) to output signals from the A/D converters 33-1 to 33-n and clock generation units 35-1 to 35-n. The decimation units 34-1 to 34-n extract samples necessary for processing at the digital signal processing unit 36 from sample sequences that are digital signals output from the A/D converters 33-1 to 33-n. In other words, the decimation units 34-1 to 34-n thin out samples other than the samples necessary for processing at the digital signal processing unit 36. Over sampling type A/D converters may be employed for the A/D converters 33-1 to 33-n.

The digital signal processing unit 36 performs a specific digital signal processing to digital signals from the decimation units 34-1 to 34-n to generate a processed output 37. A processing content of the digital signal processing unit 36 is determined correspondingly to intended use of the system function 30.

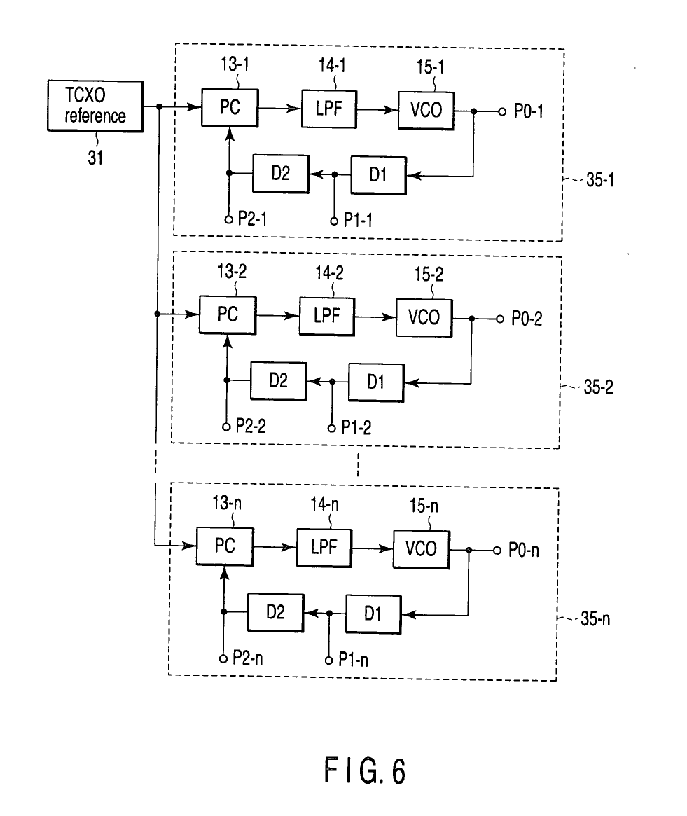

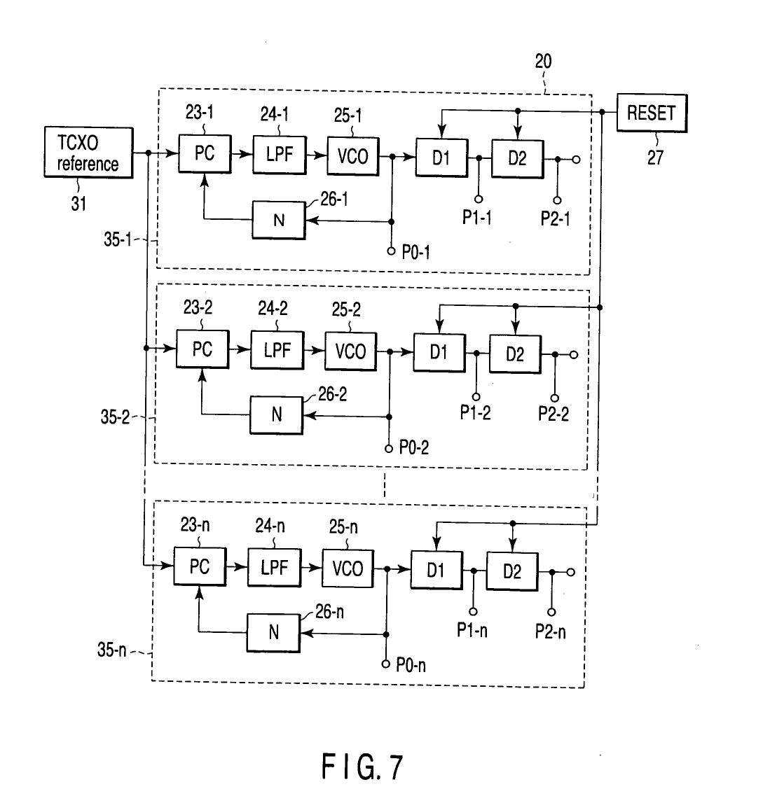

Clock generation units 35-i (i=1 to n) are configured in such a way shown in FIG. 6 or FIG. 7. The clock generation units 35-i shown in FIG. 6 are basically similar to the PLLs 12-i (i=1 to n) included in the clock generator 10 shown in FIG. 1 and include PCs 13-i (i=1 to n), LPFs 14-i (i=1 to n), VCOs 15-i

(i=1 to n) and frequency divider groups D1 and D2, respectively. That is, each clock generation unit 35-i shown in FIG. 6 has two stages of the frequency divider groups D1 to Dm (m=2) in the feedback loop of the PLL 12-i shown in FIG. 1. Reference signals are supplied from the signal source 31 to each of the clock generation units 35-i.

Outputs of the VCO 15-i get connected to output terminals P₀₋ᵢ and outputs of the frequency divider groups D1 and D2 get connected to output terminals P₁₋ᵢ and P₂₋ᵢ, respectively. In this case, as described in the first embodiment, the frequencies and phases of the clock signals at the output terminals Pⱼ₋ᵢ (j=1, 2) of the clock generation units 35-i coincide with one another. The clock signals output from the output terminal P₁₋ᵢ are supplied to the A/D converters 33-i in FIG. 5 as sampling clocks. The clock signals output from the output terminals P₂₋ᵢ are supplied to the decimation units 34-i in FIG. 5 as timing signals to determine the decimation.

On the other hand, clock generation units 35-i (i=1 to n) shown in FIG. 7 are basically similar to the clock generator 20 shown in FIG. 3 and include PLLs respectively having LPFs 24-i (i=1 to n), VCOs 25-i (i=1 to n) and frequency divider groups D1 and D2 connected in cascade with output terminals of each PLL, respectively. That is, the generation units 35-i sown in FIG. 7 have two stages of frequency divider groups D1 to Dm (m=2) shown in FIG. 1. The reference signals are supplied from the signal source 31 to each PLL. A reset signal source 39 supplies reset signals to reset initial states to the frequency divider groups D1 to Dm.

Outputs of the VCO 25-i get connected to output terminals P₀₋ᵢ and outputs of the frequency divider groups D1 and D2 get connected to output terminals Pⱼ₋ᵢ (j=1, 2), respectively. In this case, as described in the second embodiment, the frequencies and phases of the clock signals at the output terminals Pⱼ₋ᵢ (j=1, 2) coincide with one another. The clock signals output from the output terminal P₁₋ᵢ are supplied to the A/D converters 33-i in FIG. 5 as sampling clocks. The clock signals output from the output terminals P₂₋ᵢ are given to the decimation units 34-i in FIG. 5 as timing signals to determine timing of decimation.

As mentioned above, in the function system in FIG. 5, by respectively providing the clock signals to the A/D converters 33-i and decimation units 34-i from the output terminals P₁₋ᵢ and P₂₋ᵢ of the clock generation units 35-i shown in FIG. 6 or FIG. 7, the function system can synchronize every timing of the sampling and decimation at the function units 32-i. By arranging the clock generation units 35-i onto the chips with the function units 32-i respectively mounted thereon and routing the low-frequency reference clock signals toward the generation units 35-i on a substrate, the function system can suppress the increase in the power consumption and the occurrence of the EMI noise which occur in driving the wire out of the chip at a high speed.

### Fourth Embodiment

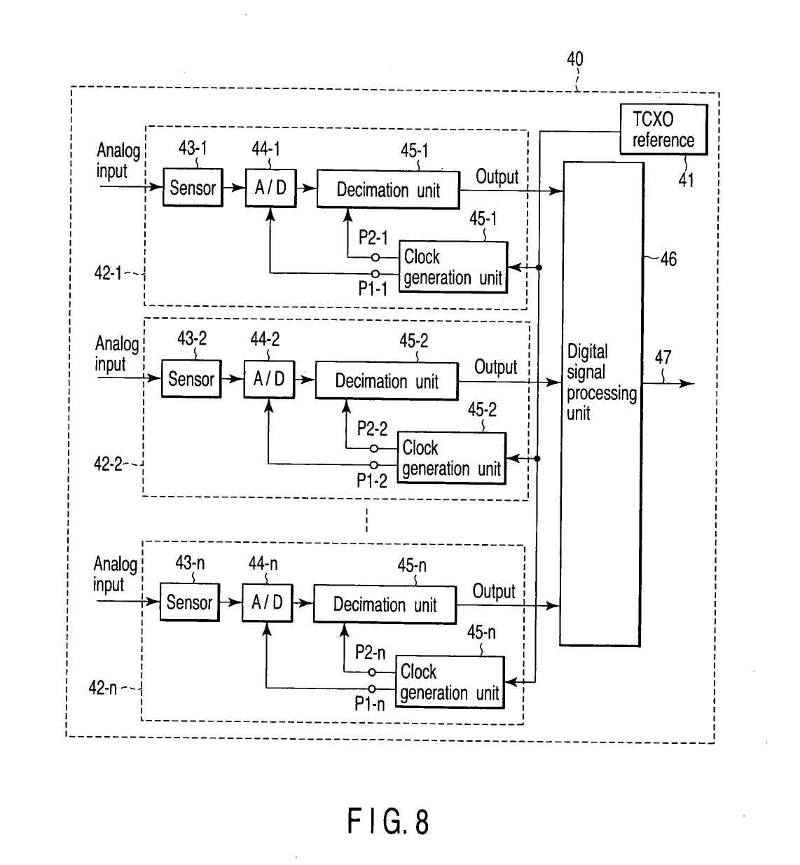

FIG. 8 shows a sensing system 40 regarding a fourth embodiment of the present invention using a clock generator. The sensing system 40 has a plurality of sensing units 42-1 to 42-n and a shared digital signal processing unit 46 for them. The sensing units 42-1 to 42-n include sensors 43-1 to 43-n sensing physical quantity to output analog signals, A/D converters 44-1 to 44-n converting analog signals output from the sensors 43-1 to 43-n into digital signals, decimation units 45-1 to 45-n decimating the digital signals output from the A/D converters 44-1 to 44-n and clock generation units 35-1 to 35-n. The sensing units 42-1 to 42-n are disposed on separate IC chips respectively.

The physical quantity to be sensing objects of the sensors 43-1 to 43-n are not limited specifically and they may include, for example, images, sounds, temperatures, pressures and humidity or the like. As a sensor of images, for example, a one-dimensional or two-dimensional imaging device is usable. As a sensor of sounds, for example, a microphone array is usable. The digital signal processing unit 46 conducts digital signal processing for an input digital signal to obtain a processed output 47 such as image data and sound data.

The generation units 35-i (i=1 to n) are shown in detail in FIG. 6 or FIG. 7. Accordingly, by supplying clock signals from output terminals P₁₋ᵢ and P₂₋ᵢ of the generation units 35-i to the A/D converters 44-i and decimation units 45-i, respectively, the system 40 can synchronize every timing of sampling and decimation for output signals from the sensors 43-i (i=1 to n).

Further, even when the sensing units 42-i (i=1 to n) are placed at positions separated from one another, by arranging the generation units 35-i onto IC chips having sensing units 42-i, respectively, and by routing low-frequency reference signals on a substrate up to the generation units 35-i, the system 40 can suppress the increase in the power consumption and the occurrence of the EMI noise which occur in driving the wire out of the chip at a high speed.

### Fifth Embodiment

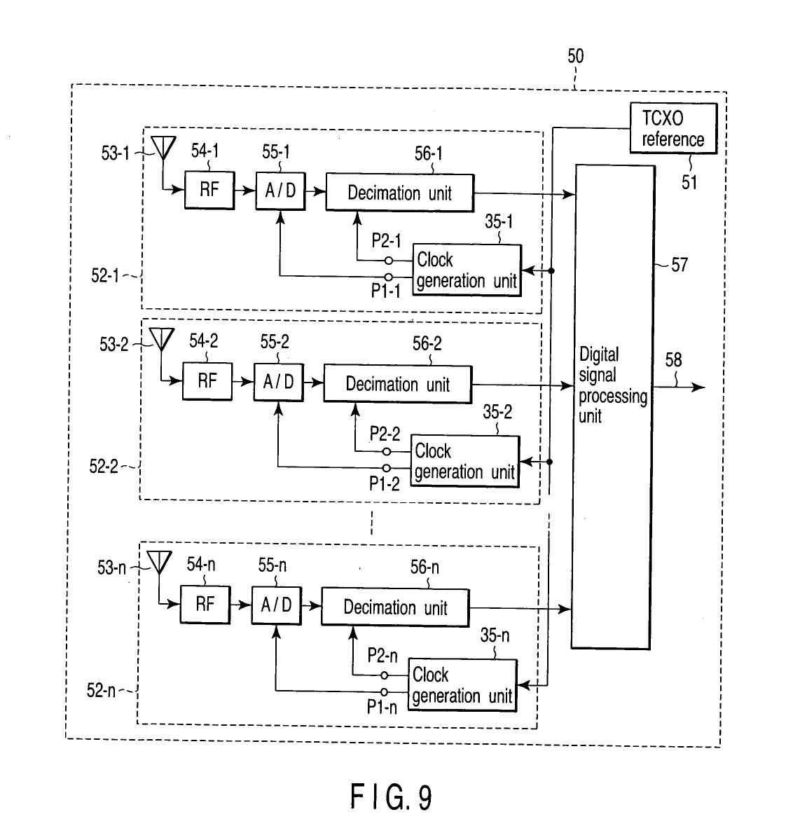

FIG. 9 shows a radio receiver 50 regarding a fifth embodiment of the present invention. The receiver 50 includes a plurality of receiving units 52-1 to 52-n and a shared digital signal processing unit 57 for them. The receiving units 52-1 to 52-n are disposed on separate IC chips, respectively. The receiving units 52-1 to 52-n includes receiving antennas 53-1 to 53-n, RF blocks 54-1 to 54-n, A/D converters 55-1 to 55-n, decimation units 56-1 to 56-n and clock generation units 35-1 to 35-n.

The receiving antennas 53-1 to 53-n receive RF signals to output analog reception signals. The reception signals from the receiving antennas 53-1 to 53-n are amplified and frequency-converted by the RF blocks 54-1 to 54-n and down-converted up to base-band signals. The base-band signals from the RF blocks 54-1 to 54-n are converted into digital signals by the A/D converters 55-1 to 55-n, and furthermore, decimated by the decimation units 56-1 to 56-n. The processing unit 57 decodes the output signals from the decimation units 56-1 to 56-n to output data 58.

For the receiver 50 including such a plurality of receiving antennas 53-1 to 53-n shown in FIG. 9, phase relationships among received signals from each antenna become important. A multi input multi output (MIMO) receiver or a diversity receiver are known as a radio receiver having a plurality of receiving antennas.

A MIMO system transmits data in parallel from a radio transmitter by using a plurality of transmitting antennas. On the other hand, a radio receiver called a MIMO receiver receives RF signals transmitted from the transmitter via a space propagation path at a plurality of receiving antennas and demodulates and decodes the received signals by applying signal processing called MIMO signal processing to reproduce original data. The diversity receiver performs diversity combining to the received signals from the plurality of receiving antennas on the basis of a variety of known algorisms then demodulates and decodes to reproduce them. The processing unit 57 conducts the MIMO signal processing and diversity combining processing.

In there cases, it is important that phases of received signals which are input to the processing unit 57 from the receiving antennas 53-i (i=1 to n) through the RF blocks 54-i, A/D converters 55-i and decimation units 56-i coincide with one another. Therefore, it is necessary for the received signals to be sampled at the same timing at the A/D converters 55-i and also to be decimated at the same timing at the decimation units 56-i in latter stages. Furthermore, it is desirable that phase relations of the clock signals provided to the A/D converters 55-i and provided to decimation units 56-i are constant. Because when the timing of the clock signals supplied to the A/D converters 55-i and decimation units 56-i are in random, the phase relations among each signal received by the receiving antennas 53-i become unrecognizable.

The clock generation units 35-i (i=1 to n) are shown in detail in FIG. 6 or FIG. 7. That is, the frequencies and phases of the clock signals at the output terminals Pⱼ₋ᵢ (j=1, 2) of the generation units 35-i coincide with one another, and further, the phase relations of the clock signals at the output terminals P₁₋ᵢ and at the output terminals P₂₋ᵢ are always constant.

Accordingly, by supplying the clock signals from the output terminals P₁₋ᵢ and P₂₋ᵢ of the generation units 35-i to the A/D converters 54-i and decimation units 55-i, respectively, the radio receiver 50 can synchronize every timing of the sampling and decimation to the signal input to the A/D converters 55-i and decimation units 56-i through the RF blocks 54-i from the receiving antennas 53-i. Thereby, since the radio receiver 50 can maintain the phase relations among each received signal which is output from the receiving antennas 53-1 to 53-n, it can well perform the MIMO signal processing and diversity combining processing at the signal processing unit 57.

Even when the receiving units 52-i (i=1 to n) are positioned separately from one another, by arranging the clock generation units 35-i on the IC chips with each unit 52-i respectively mounted thereon and by routing the low-frequency reference clock signals on the substrate up to the generation units 35-i, the radio receiver 50 can suppress the increase in the power consumption and the occurrence of the EMI noise which occur in driving the wire out of the chip at a high speed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A clock generator comprising:
a plurality of phase locked loops, each receiving reference signals from a shared reference signal source to generate a plurality of clock signals differing in frequency, respectively;
each of the phase locked loops including:
a phase comparator which compares a phase of the reference signal with a phase of a feedback signal to generate a voltage signal in response to a phase difference between the reference signal and the feedback signal;
a voltage controlled oscillator of which the output signal is controlled in frequency by a voltage signal;
a feedback loop disposed between an output of the voltage controlled oscillator and an input of the feedback signal of the phase comparator;
a first frequency divider which is connected to the voltage controlled oscillator in the feedback loop to output a first clock signal;
a second frequency divider which is connected to the first frequency divider to output a second clock signal;
a first output terminal which takes out the first clock signal; and
a second output terminal which takes out the second clock signal.

2. The clock generator according to claim 1, wherein each of the phase locked loops further including:
at least one of frequency dividers which are connected in cascade to the second frequency divider in the feedback loop to output a clock signals, respectively; and
at least one of output terminals which output the clock signals, respectively.

3. A radio receiver comprising:
a plurality of receiving units;
each of the receiving units including:
an antenna which receives a high-frequency signal to generate an analog reception signal;
an RF unit which down-converts the analog reception signal to generate a base band signal;
an analog-to-digital converter which converts the base band signal into a digital signal;
a decimation unit which decimates the digital signal to generate a digital signal for demodulation;
a digital signal processing unit which performs digital signal processing to the digital signal for the demodulation to reproduce data; and
the clock generator according to claim 1, which supplies clock signals differing in frequency to the analog-to-digital converter and the decimation unit, respectively.

4. A function system comprising:
a plurality of function units;
each of the function units including:
an analog-to-digital converter which converts an analog signal into a digital signal;
a decimation unit which decimate the digital signal to generate a digital signal for demodulation;
a digital signal processing unit which performs digital processing to the digital signal for the demodulation to reproduce data; and
the clock generator according to claim 1, which supplies clock signals differing in frequency to the analog-to-digital converter and the decimation unit, respectively.

5. A sensing system comprising:
a plurality of sensor units;
each of the sensor units including:
a sensor which senses physical quantity to output it as an analog signal;
an analog-to-digital converter which converts the analog signal into a digital signal;
a decimation unit which decimates the digital signal to generate a digital signal for demodulation;
a digital signal processing unit which performs digital processing to the digital signal for the demodulation to reproduce data; and
the clock generator according to claim 1, which supplies clock signals differing in frequency to the analog-to-digital converter and the decimation unit, respectively.

6. The sensing system according to claim 5, wherein the physical quantity is at least one of an image, a sound, a temperature, a pressure or humidity.

7. A clock generator comprising:
a plurality of phase locked loops each receiving reference signals from a shared reference signal source to generate output signals synchronized with the reference signals, respectively;
a plurality of frequency divider groups each of which are connected in cascade with each output of the phase locked loops and can reset initial states of the frequency divider groups; and
a plurality of output terminals each of which take out clock signals differing in frequency from each of the plurality of frequency divider groups, respectively.

8. The clock generator according to claim 7, wherein each of the phase locked loops including:
a phase comparator which compares phase of the reference signal with a phase of a feedback signal to generate a voltage signal in response to a phase difference between the reference signal and the feedback signal;
a voltage controlled oscillator of which the output signal is controlled in frequency by a voltage signal;
a output terminal which takes out output signal from the voltage controlled oscillator;
a feedback loop disposed between an output of the voltage controlled oscillator and an input of the feedback signal of the phase comparator; and
a frequency divider which is connected to the voltage controlled oscillator in the feedback loop.

9. A radio receiver comprising:
a plurality of receiving unit;
each of the receiving unit including:
an antenna which receives a high-frequency signal to generate an analog reception signal;
an RF unit which down-converts the analog reception signal to generate a base band signal;
an analog-to-digital converter which converts the base band signal into a digital signal;
a decimation unit which decimates the digital signal to generate a digital signal for demodulation;
a digital signal processing unit which performs digital signal processing to the digital signal for the demodulation to reproduce data; and
the clock generator according to claim 7, which supplies clock signals differing in frequency to the analog-to-digital converter and the decimation unit, respectively.

10. A function system comprising:
a plurality of function units;
each of the function units including:
an analog-to-digital converter which converts an analog signal into a digital signal; and
a decimation unit which decimate the digital signal to generate a digital signal for demodulation;
a digital signal processing unit which performs digital processing to the digital signal for the demodulation to reproduce data; and
the clock generator according to claim 7, which supplies clock signals differing in frequency to the analog-to-digital converter and a decimation unit, respectively.

11. A sensing system comprising:
a plurality of sensor units;
each of the sensor units including:
a sensor which senses physical quantity to output it as an analog signal;
an analog-to-digital converter which converts the analog signal into a digital signal;
a decimation unit which decimates the digital signal to generate a digital signal for demodulation; and
a digital signal processing unit which performs digital processing to the digital signal for the demodulation to reproduce data; and
the clock generator according to claim 7, which supplies clock signals differing in frequency to the analog-to-digital converter and a decimation unit, respectively.

12. The sensing system according to claim 11, wherein the physical quantity is at least one of an image, a sound, a temperature, a pressure or humidity.
